(19) United States
(12) Patent Application Publication
(10) Pub. No.: US 2022/0393446 A1
(43) Pub. Date: Dec. 8, 2022

(54) WIRE STRIPPERS, WIRE CUTTERS, AND RELATED METHODS OF USE

(71) Applicant: Colby Whipple, County of Grande Prairie (CA)

(72) Inventor: Colby Whipple, County of Grande Prairie (CA)

(21) Appl. No.: 17/827,246

(22) Filed: May 27, 2022

(30) Foreign Application Priority Data
Jun. 4, 2021 (CA) 3,121,075

(51) Int. Cl. H02G 1/12

(52) U.S. Cl. CPC H02G 1/1256

(57) ABSTRACT

A wire stripper part or assembly uses two or more elements for a blade roller, with one element being a cutter, and the other element or elements being a guide element that keeps the wire aligned with the cutter. A tri-blade self-centering wire stripper knife is also described. A wire stripper has: a structural frame; parallel rollers mounted on the structural frame to rotate relative to one another, one of the parallel rollers being a feed roller and the other being a blade roller; and in which the blade roller has a wire cutter comprising a cutting blade and one or more circumferential guide shoulders, with the wire cutter aligned with a wire-gripping portion of the feed roller to define a wire-cutting zone. Methods of use are described.

### TECHNICAL FIELD

This document relates to wire strippers, wire cutters, and related methods of use.

### BACKGROUND

The following paragraphs are not an admission that anything discussed in them is prior art or part of the knowledge of persons skilled in the art.

Wire strippers include a class of machines where a wire is inserted between parallel rotating rollers, and a blade on one of the rollers cuts an insulated sheath of the wire, to permit the insulated sheath to be separated from the more valuable metal core of the wire.

### SUMMARY

A wire stripper part or assembly is disclosed, that uses two or more elements for a blade roller, with one element being a cutter, and the other element or elements being a guide element that keeps the wire aligned with the cutter.

A tri-blade self-centering wire stripper knife is also disclosed.

A wire stripper is disclosed comprising: a structural frame; parallel rollers mounted on the structural frame to rotate relative to one another, one of the parallel rollers being a feed roller and the other being a blade roller; and in which the blade roller has a wire cutter comprising a cutting blade and one or more circumferential guide shoulders, with the wire cutter aligned with a wire-gripping portion of the feed roller to define a wire-cutting zone.

A wire cutter ring is disclosed comprising: a ring body defining a central blade roller-receiving bore; the ring having an external circumferential surface that defines: a circumferential cutting blade; and left and right circumferential guide shoulders spaced between axial ends of the ring body on either side of the circumferential cutting blade.

A method is disclosed comprising inserting a wire, which has a wire core and a insulative sheath, along an axis of the wire, through a wire-cutting zone, which is defined by a) a wire-gripping portion of a feed roller, and b) a wire cutter of a blade roller, the wire cutter comprising a cutting blade and one or more circumferential guide shoulders, the feed roller and the blade roller forming parallel rollers, in which during insertion of the wire, the blade roller and the feed roller are rotated relative to one another to grip the wire and to permit the cutting blade to form a longitudinal cut along the insulative sheath.

A wire stripper is disclosed comprising: a structural frame; parallel rollers mounted on the structural frame to rotate relative to one another, one of the parallel rollers being a feed roller and the other being a blade roller; and in which the blade roller has a wire cutter comprising two or more cutting blades, with the wire cutter aligned with a wire-gripping portion of the feed roller to define a wire-cutting zone. The two or more cutting blades may comprise one or more circumferential guide shoulders.

A kit is disclosed comprising the feed roller and blade roller.

In various embodiments, there may be included any one or more of the following features: The parallel rollers are structured to, in use, receive a wire that is inserted into the wire-cutting zone in a longitudinal direction between the parallel rollers, such that the wire contacts the feed roller, the cutting blade, and the one or more circumferential guide shoulders to direct the wire between the parallel rollers while the cutting blade longitudinally cuts the insulative sheath of the wire. The feed roller has circumferential shoulders that are spaced between axial ends of the feed roller to define a circumferential wire-receiving channel that defines the wire-gripping portion and at least partially defines the wire-cutting zone. The feed roller and the blade roller mesh together with the wire cutter fitting at least partially within the circumferential wire-receiving channel. The cutting blade and a center axis of the circumferential wire-receiving channel are parallel and defined in the same plane; and the one or more circumferential guide shoulders are aligned with one or more of opposed side walls of the circumferential wire-receiving channel. The opposed side walls of the circumferential wire-receiving channel are tapered, and the one or more circumferential guide shoulders are V-shaped in cross-section with outer faces following the taper of the opposed side walls. The feed roller defines a series of wire-gripping portions spaced between the axial ends of the feed roller; the blade roller defines a series of wire cutters spaced between the axial ends of the blade roller; and the series of wire-gripping portions and the series of wire cutters cooperate to define a series of wire-cutting zones, with each wire-cutting zone being defined by a respective wire cutter and a respective wire gripping portion. Each wire-cutting zone has a respective axial width corresponding to a maximum feed wire diameter, with the respective axial widths of each wire-cutting zone being different from one another. The feed roller comprises a feed spindle that defines the wire-gripping portion; and the blade roller comprises a blade spindle mounting the wire cutter as at least one ring that defines the wire cutting blade and one or more circumferential guide shoulders. The ring is reversibly mounted on the blade spindle. Each of the wire cutting blade and one or more circumferential guide shoulders are defined by independent rings. The wire cutter comprises the wire cutting blade and one circumferential guide blade. The one or more circumferential guide shoulders comprise left and right circumferential guide shoulders aligned on either side of the cutting blade. The one or more circumferential guide shoulders comprise one or more guide blades. The cutting blade comprises two or more cutting blades. A roller drive connected to rotate one or both of the feed roller and blade roller. In which the parallel rollers comprise a first pair of parallel rollers; the wire stripper comprises a second pair of parallel rollers; and in which the first pair aligns with the second pair to define a wire receiving path. A wire feed guide conduit structured to receive and permit passage, in use, of the wire into the wire-cutting zone between the parallel rollers. Rotating one or both of the feed roller and the blade roller of the wire stripper to cut an insulative sheath from a wire that is inserted within the wire-cutting zone. The left and right circumferential guide shoulders comprise left and right circumferential guide blades. Separating the insulative sheath from the wire after or during removal of the wire from the wire-cutting zone. The one or more circumferential guide shoulders comprise left and right circumferential guide shoulders on either side of the cutting blade; and during insertion of the insulated wire, the left and right circumferential guide shoulders guide the wire into contact with the cutting blade.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a perspective view of a wire stripper machine.

FIG. 2 is a side elevation view illustrating the wire stripper machine of FIG. 1 simplified to illustrate a roller adjustment bracket.

FIG. 3 is side elevation view of an arrangement of two pairs of parallel rollers aligned with one another in the wire stripper of FIG. 1 to collectively grip and cut a wire.

FIG. 4 is a top plan view of a pair of parallel rollers used in the wire stripper of FIG. 1, with an example wire-cutting zone shown in dashed lines.

FIGS. 5 and 6 are side and end elevation views of a wire cutter ring used in the wire stripper of FIG. 1, with an internal bore of the wire cutter ring shown in dashed lines in FIG. 5.

FIG. 7-15 are side elevation views of various embodiments of wire cutter rings, with the internal bores of same delineated in dashed lines.

FIG. 16 is a side elevation view of an embodiment of a wire cutter made of three independent cutter rings assembled in spaced relationship to one another on a blade spindle.

### DETAILED DESCRIPTION

Immaterial modifications may be made to the embodiments described here without departing from what is sheathed by the claims.

Conductor wires are used throughout infrastructure to conduct electricity for various purposes. A conductor wire may include a core capable of conducting electricity. For example, a wire core may comprise plural cylindrical strands of metal, such as made of copper, silver or aluminum. Conductor wires may be shielded or otherwise protected with an external insulative sheath that surrounds the core. An insulative sheath may be made from nonconductive material that shields the sheath from inadvertent contact with grounded or other conductive items, to avoid short circuiting, unwanted power loss, and sparking, which could otherwise cause damage to a system and related infrastructure. Wire insulation may protect the core materials from threats such as humidity and heat, which may otherwise degrade the conductive ability of the core. The insulation of the wires is a protective measure whose thickness and quality dictates the safety and effectiveness of the conductor wires.

A conductor wire that is no longer needed, useful, or operational may be recycled or discarded. A conductor wire may need to be replaced, repaired, recycled, or discarded for various reasons, for example when the conductor wire or equipment containing the conductor wire reaches the end of its respective lifespan or becomes damaged. To recycle a wire, it may be desirable to separate the insulative sheath from the core, in order to access the relatively more valuable materials that make up the core. Various methods may be used to separate the insulative sheath from the core, for example manual methods that include manually cutting and ripping the sheath off the core, to automated methods that use wire stripper machines to cut and strip the wire.

Manual methods of wire stripping may include using any of various handheld devices or hand tools. Portable, hand-held tools that may be used to remove insulation from electrical wires include various forms of pliers, often the define apertures between pairs of cutting blades for stripping wires of different circumferences. A wire may be gripped within one of such apertures, at which point, assuming the correct aperture is selected, the opposed blades will cut into the insulative sheath (but not the core itself), and the pliers may then be used to slide the sheath off of the metal wiring. Various pliers and other manual wire stripping tools may be only applicable for stripping electrical wires with relatively small circumferences.

Automatic methods may also be used to strip a wire, with such methods incorporating the use of wire stripper machines. In general, a wire stripper machine will be capable of stripping the insulative cover off of a greater range of diameter of wires than would be possible with manual methods. A wire stripper machine may use a motor and a variety of rollers to feed a cable in one end and out of the other end of the machine with the insulation and metal wire separated. Electronic or mechanical controls may be provided depending on the model. In one version of a wire stripper machine, a wire is fed between a pair of rollers, and a single blade on one of the rollers makes a longitudinal cut along at least part of the axial length of the wire. In theory, the use of a wire stripper machine achieves the goal of making the process of separating the cable insulation from the metal core faster and easier. However, in practice, conventional wire stripper machines have room for improvement.

One example of a wire stripper machine is a WS-212™ BLUEROCK™ offered by the Newman Trading Company of Washington, U.S.A. The WS-212™ wire stripping machine operates on a dual spindle mechanism, where one part is responsible for feeding in the cable, while the other spindle cuts through the insulation material. The wire stripper also has an adjustment device that can adjust the depth of the blade to accommodate for different insulation thickness. The position of the blade may also be adjusted axially to accommodate situations where the blades deviate from cutting a straight line while slicing through the insulation. The spindles that cut the insulation of the cable wires are enclosed in a protected casing. The WS-212™ and like machines are prone to various issues in operation, such as blade walk, wire walk, and improper or insufficient cutting of the insulative sheath. In some cases, a wire may need to be re-run through the machine several times to achieve the desired degree of separation of sheath from core.

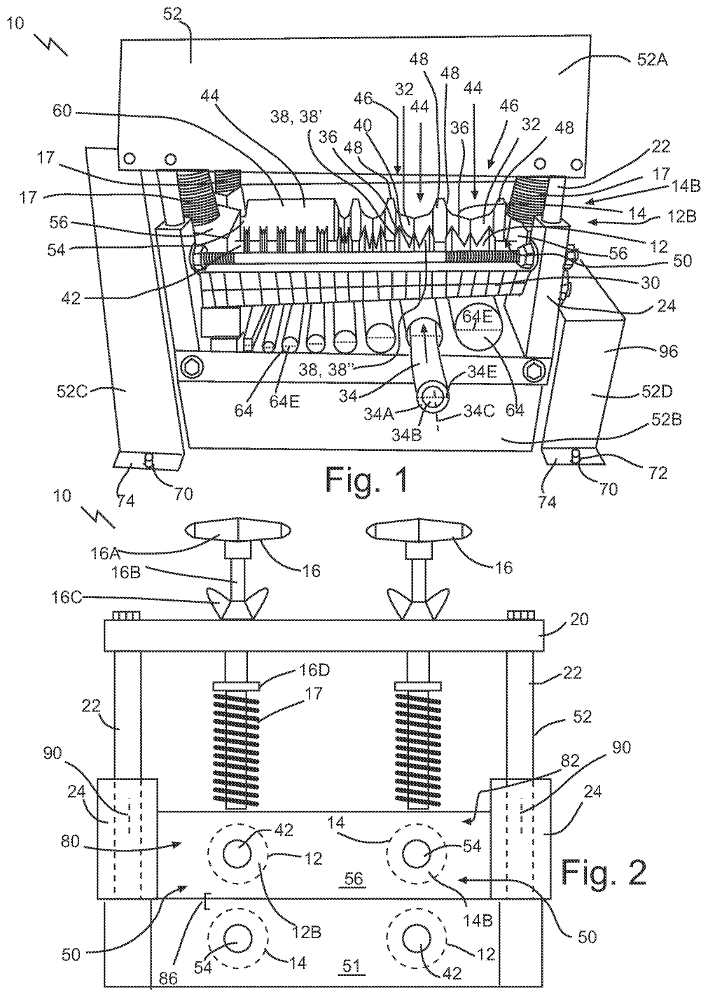

Referring to FIGS. 1 and 4, a wire stripper 10 is illustrated. The wire stripper 10 has a wire cutter 36. The wire cutter 36 has a cutting blade 40 and one or more circumferential guide shoulders 38. The stripper 10 may have parallel rollers 50, such as a blade roller 12 and feed roller 14. The blade roller 12 may define or mount the wire cutter 36. The feed roller 14 may define or mount a wire gripping portion 44. The wire cutter 36 may be aligned in use with wire-gripping portion 44 of the feed roller 14 to define a wire-cutting zone 32. Gripping portion 44 may be defined by one or more circumferential feed shoulders 48 on the feed roller 14. The feed shoulders 48 may define a wire receiving channel 46, which may at least partially define the wire-cutting zone 32 (in FIG. 4 the zone 32 is illustrated in dashed lines). The wire cutter 36 may be located between axial ends 12B of the blade roller 12. The wire gripping portion 44 may be located between axial ends 14B of the feed roller 14. Referring to FIG. 1, the wire stripper 10 may include a structural frame 52, such as forming a housing that mounts the various parts of the stripper 10. The parallel rollers 50 may be mounted on the structural frame 52 to rotate relative to one another, for example to grip and cut a wire 34 in use.

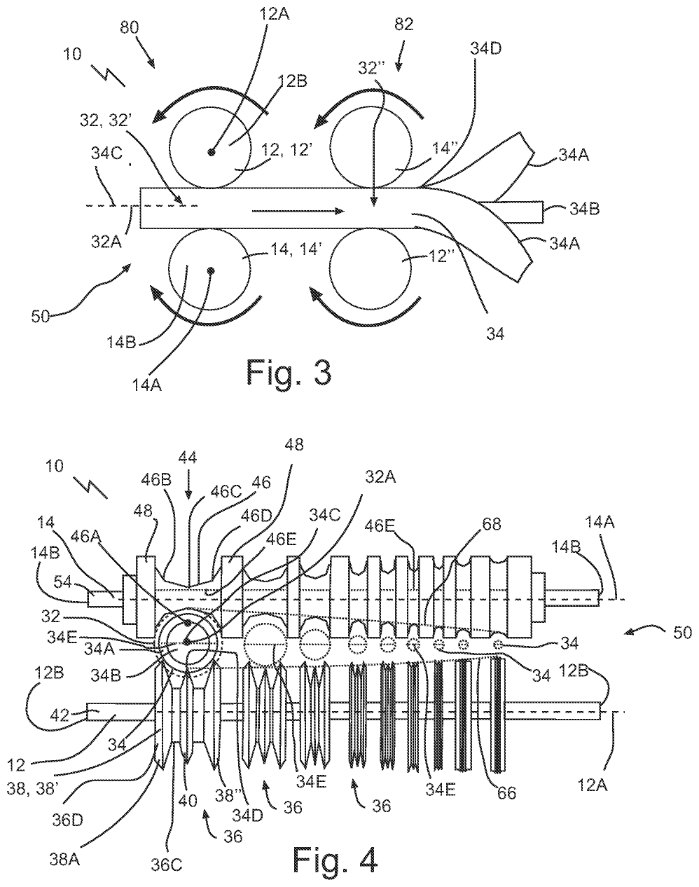

Referring to FIGS. 1-4, the wire stripper 10 may be used to cut at least an insulated sheath 34A of a wire 34. During use, the parallel rollers 50 may be rotated relative to one another to cut, and in some cases strip, the insulated wire 34. Referring to FIG. 3, the blade roller 12, the feed roller 14, or both may be rotated, for example in opposite directions, to draw the wire 34 into and through the wire-cutting zone 32. Referring to FIGS. 1, 3, and 4, the wire 34 may be in use inserted into the wire-cutting zone 32 of the wire stripper 10 and into contact with the parallel rollers 50. During the insertion of the wire 34, one or both of the blade roller 12 and feed roller 14 may grip the wire 34, for example to pull the wire 34 through the cutting zone 32. The cutting blade 40 may pierce and form a longitudinal cut 34D along the insulation sheath 34A of the wire 34, for example parallel to a wire axis 34C of the wire 34. Thus, the wire 34 may be inserted into the wire-cutting zone 32 in a longitudinal direction (for example defined by the wire axis 34C) between the parallel rollers 50, where the wire 34 is contacted by the feed roller 14, the cutting blade 40, and the one or more guide shoulders 38, to direct the wire 34 between the parallel rollers 50 while the cutting blade 40 longitudinally cuts the insulative sheath 34A of the wire 34.

Referring to FIGS. 1 and 4, the wire cutter 36 may have more than one circumferential guide shoulders 38, for example two or more shoulders 38. In the example shown, the one or more guide shoulders 38 comprise left and right guide shoulders 38′ and 38″ aligned on either side of the cutting blade 40. During insertion of the insulated wire 34, the left and right guide shoulders 38 may guide the wire 34 into contact with the cutting blade 40. For example, the shoulders 38 may both compress and center or otherwise guide the wire 34 into contact with the blade 40, for example to reduce or eliminate the possibility of wire walking, which occurs when a wire 34 slides laterally to one side of the blade 40 and thus is either not cut at all or is cut in a way that is insufficient to thereafter conveniently separate the sheath 34A from the core 34B. The one or more guide shoulders 38 may comprise one or more guide blades, for example as shown. The use of blades may be advantageous to improve gripping of the wire 34, as the tips of the blades may dig in to the sheath 34A.

Referring to FIGS. 1 and 4, the parallel rollers 50 may incorporate spindles, such as a blade spindle 42 of the blade roller 12 and a feed spindle 54 of the feed roller 14. Referring to FIGS. 3 and 4, the blade spindle 42 of the blade roller 12 may define an axis 12A of the blade roller 12, and may align in parallel to the feed spindle 54 of the feed roller 14. The blade spindle 42 may mount one or more of the wire cutters 36 and may define the blade roller 12. The feed spindle 54 of the feed roller 14 may define an axis 14A of the feed roller 14 and may be aligned in parallel to the blade spindle 42 of the blade roller 12. The feed spindle 54 of the feed roller 14 may have one or more wire-gripping portion 44, for example plural portions 44 as shown. The wire-gripping portion 44 may be defined by, for example between, one or more circumferential feed shoulders 48 mounted onto the feed spindle 54. Referring to FIGS. 1 and 2, the blade roller 12 and the feed roller 14 of the parallel rollers 50 may be arranged by mounting the blade spindle 42 and the feed spindle 54 onto a bracket 56 of the wire stripper 10. The spindles may form axles as shown. The spindles may have a suitable shape, such as a hollow or solid cylinder. The shoulders 38 and/or 48 may be defined on the respective spindles either integrally (for example by a lathe indenting process) or non-integrally (for example by mounting appropriately shaped rings over the spindle, and then securing the rings to the spindle by a suitable method, such as welding, adhesive, or fasteners).

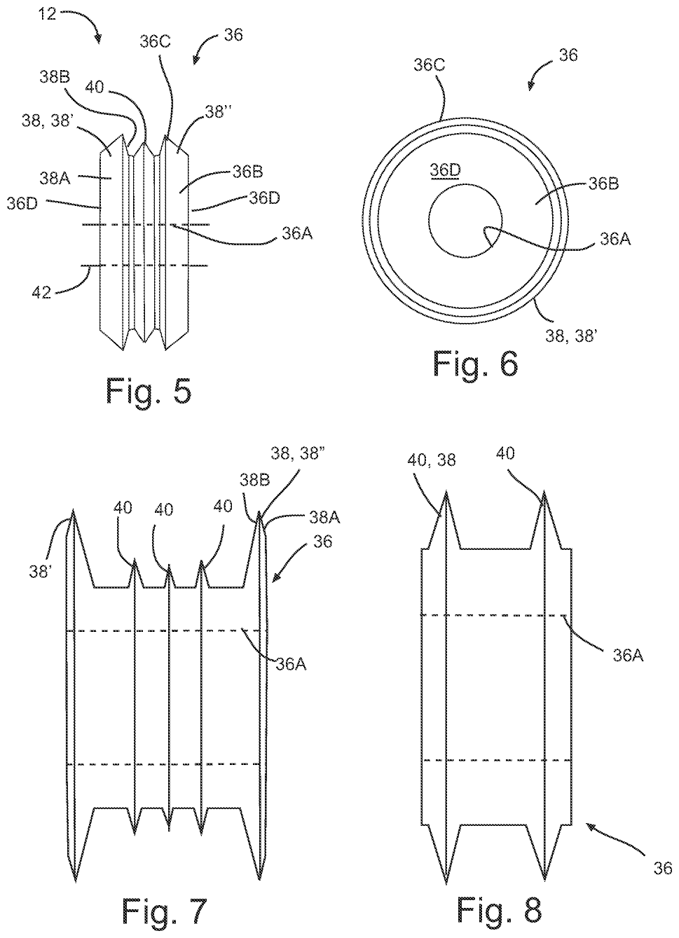

Referring to FIG. 4-6, the wire cutter 36 may be mounted as a ring that defines the cutting blade 40 and one or more guide shoulders 38. One or more wire cutters 36 may be mounted onto the blade spindle 42 as a ring, for example a ring that is slid onto the external circumferential surface of the spindle 42. The wire cutter 36 may have a ring body 36B defining a central blade roller-receiving bore 36A, to which the blade spindle 42 may be inserted and contacted. In the example shown, the wire cutter 36 may define an external circumferential surface 36C and an external axial surface 36D. The surface 36C may define or otherwise form the cutting blade 40 and one or more circumferential guide shoulders 38. The left circumferential guide shoulder 38′ and right circumferential guide shoulder 38″ may be spaced between the axial ends (represented by opposed axial surfaces 36D) of the wire cutter 36 on either side of the cutting blade 40. The wire cutter 36 may be mounted onto the blade spindle 42 by sliding the ring body 36B over the spindle 42 so that the ring body 36B and central blade roller-receiving bore 36A are coaxial as shown in FIG. 4. The central blade roller-receiving bore 36A may be sized to fit onto the blade spindle 42 with suitable tolerance, for example a close fit tolerance or an interference fit. The use of a ring as a wire cutter 36 may allow a user to retrofit an existing blade roller 12 to incorporate the wire cutter 36. The wire cutter 36 may in use have the ring reversibly mounted onto the blade spindle 42, for example to permit the ring to be removed and replaced or repaired. It may be advantageous to be able to remove and reinstall the wire cutter 36 from the spindle 42 to allow the various blades of the wire cutter 36 to be sharpened.

Referring to FIGS. 1 and 4, the feed roller 14 may be structured such that the wire gripping portion 44 is defined by a circumferential wire-receiving channel 46. The wire-gripping portion 44 may have one or more circumferential feed shoulders 48 that are spaced between axial ends 14B of the feed roller 14 to define the circumferential wire-receiving channel 46. The channel 46 and wire cutter 36 may cooperate together to introduce contact between the wire 34, the wire cutter 36 and the wire-gripping portion 44. When the wire 34 is inserted in the wire cutting zone 32, the wire 34 may be inset at least partially within the channel 46 and sandwiched, for example compressed, between the channel 46 and wire cutter 36. A slight or moderate compression may increase the amount of gripping friction between the rollers 50 and the wire 34, improving the feed of the wire 34 through the stripper 10. The channel 46 may be shaped to have a pair of side walls 46B and 46D, and a web or base 46C. In the example shown the walls 46B and 46D, and the base 46C are curved, for example in a concave fashion, for example to at least partially follow a curved outer profile of the wire 34, to seat the wire 34 in the channel 46.

Referring to FIG. 4, the feed roller 14 and the blade roller 12 of the parallel rollers 50 may be aligned in use. The cutting blade 40 of the wire cutter 36 may be aligned in a plane defined perpendicular to the axes 12A and 14A. The cutting blade 40 may be arranged such that the blade 40 and a center axis 46A of the circumferential wire-receiving channel 46 are defined in the same plane, for example a plane perpendicular to the axes 12A and 14A. The axis 46A may be defined directly adjacent the base 46C of the channel 46. The opposed side walls 46B, 46D of the circumferential wire-receiving channel 46 may be tapered, for example with increasing depth in directions toward the center axis 46A of the channel 46. The tapering of the side walls 46B, 46D of the channel 46 may cooperate to improve alignment, fitting, and/or meshing with the guide shoulders 38 of the wire cutter 36. The one or more guide shoulders 38 may be tapered, for example may have a V-shape in cross-section as shown. Outer axial faces 38A of the guide shoulders 38 may follow the taper of the opposed side walls 46B, 46D of the circumferential wire-receiving channel 46. For example, the left guide shoulder 38′ may be aligned with a left side wall 46B, and the right guide shoulder 38″ may be aligned with a right-side wall 46D. The orientation and tapering of the feed roller 14 and the blade roller 12 may allow for the wire 34 to be gripped.

Referring to FIG. 1, the feed roller 14 may be structured to define one or more wire gripping portion 44, such as a portion 60, that has a shape other than a channel 46 shape, for example a cylindrical shape as shown. One of the functions of the feed roller 14 may be to grip the wire 34 to pull the wire 34 through the zone 32, and shapes other than a channel 46 may achieve this function. Similarly, cylindrical portion 60 may cooperate with the blade roller 12 to grip the wire 34. The external surface of the feed roller 14 may be structured to increase friction with, and hence grip of, the wire 34, for example by knurling the surface or providing other texture or texturing elements, such as nubs or teeth, to improve gripping. A cylindrical portion 60 may be advantageous for use of stripper 10 with relatively smaller wire diameters, which may be more susceptible to nicking or core damage when passed through a stripper 10 than would a larger diameter wire 34 be. In one example, a cylindrical feed portion 60 is used for twelve and greater gauge wires 34, while the scallops or channels 46 are used for below twelve-gauge wires 34. A cylindrical portion 60 is just one example of a shape of portion 44 that might flatten or partially flatten the wire 34, for example under compression, increasing the width of insulative sheath 34A that is exposed to the blade 40 during use, and potentially improving the efficiency of the cutting of such wires 34. It may be advantageous to avoid nicking of the wire core 34B while stripping as such may damage the core 34B and may reduce the amount of core 34B that can be collected from a stripping process. The wire gripping portion 44 may be structured with other shapes, such as convex shapes, or more complex shapes that are structured to grip the wire 34.

Referring to FIGS. 1 and 4, the wire stripper 10 may be structured to cut a variety of gauges of wire 34, using a plurality of different wire zones 32. Wire gauge is a measurement of wire diameter, with diameter being one factor that determines the amount of electric current the wire can safely carry, as well as its electrical resistance and weight. Referring to FIG. 4, the stripper 10 may form a series of wire zones 32. The blade roller 12 may define a series of (a plurality of) wire cutters 36 spaced between the axial ends 12B of the blade roller 12. The feed roller 14 may define a series of (a plurality of) wire-gripping portions 44 spaced between the axial ends 14B of the feed roller 14. The series of wire-gripping portions 44 and the series of wire cutters 36 may thus cooperate to define the series of wire-cutting zones 32, with each wire-cutting zone 32 defined by a respective wire cutter 36 and a respective wire gripping portion 44. The different widths and tension capacity of the series of wire zones 32 may allow for wires 34 of different gauges to be stripped in the wire stripper 10 such as shown.

Referring to FIG. 4, as above, the wire zones 32 may be structured to receive wires 34 of different diameters 34E. Each wire-cutting zone 32 may define the axial width corresponding to the maximum feed wire diameter 34E of the respective wire 34 that the zone 32 is structured to fit. For example, for the seven zones 32 from the left in the example in FIG. 4, the axial width 46E of each channel 46 determines the maximum diameter 34E of wire 34 for that channel 46. In the example shown, for the two zones 32 from the right, the maximum wire diameters 34E are smaller than the axial widths 46E of each channel 46, although in some cases the axial width 46E of channel 46 may govern wire diameter 34E for all zones 32 in other cases. The axial widths of each wire-cutting zone 32 may be collectively defined by the pair of wire cutter 36 and the respective wire receiving channel 46. The provision of one or more zones 32 as shown may allow for one or more types and gauges of wire 34 to be processed in the wire stripper 10.

Referring to FIG. 4, dashed lines are used to indicate an example of cutter and base paths 66 and 68, that track the maximum dimensions of the cutting blade 40 and base 46C, respectively for parallel rollers that form a series of wire-cutting zones 32. In the example shown, the profiles both taper away from the respective spindle with decreasing maximum wire diameter 34E of the respective zone 32. Such an orientation may be advantageous to permit separation distance adjustments between the rollers 12 and 14 without one zone 32 obstructing another zone 32.

Referring to FIG. 1, the insulated wire 34 may be introduced to the wire stripper 10 through a feed guide conduit 64. The wire feed guide conduit 64 may be structured to receive the wire 34 and may permit passage of the wire 34 into the wire-cutting zone 32 between the parallel rollers 50. The conduit 64 may be sized to restrict entry of a wire 34 of larger diameter 34E than the axial width or diameter 64E of the conduit 64. Thus, the conduit 64 may act to both guide the wire 34 into the respective wire cutting zone 32, and act as a limit to prevent oversized wires 34 from entering the wrong zone 32. A series of feed guide conduits 64 may be structured and oriented to feed individual respective wires 34 into each of the series of wire zones 32 that may allow the insulated wire 34 to come into contact with the parallel rollers 50 through the corresponding wire cutting zone 32. The feed guide conduits 64 may also act as a visual aid to a user to assist the user in selecting the appropriate wire-cutting zone 32 for any given wire diameter 34E. In practice a user may select the smallest diameter conduit 64 in which the wire 34 may fit, although in some cases two or more conduits 64 may fit a given wire 34.

Referring to FIG. 1, as above, the wire stripper 10 may incorporate structural frame 52 to support and adjust the rollers 50. The frame 52 may have various structural members, such as one or more of a top member 52A, base member 52B, and left and right-side members 52C and 52D, respectively. The frame 52 may be formed by plural cross members and upright members as shown. The frame 52 may comprise or one or more panels. The frame 52 may at least partially enclose the parallel rollers 50, in order to shield the rollers 50 during use, for reasons of safety and reliability. In terms of safety, the frame 52 may form a protective shield to prevent or restrict an operator from being able to inadvertently access the wire cutting zones 32 or the blade roller 12. One or more fences 30 may be provided to permit visual access but not physical access to the zones 32. The frame 52 may have other components, such as mounting parts (for example apertures 70 to mount fasteners 72 through feet 74 of the frame 52 to mount the frame 52 on a work surface).

Referring to FIGS. 2 and 3, the wire stripper 10 may have two or more pairs of parallel rollers 50. In a wire stripper 10, one or more pairs of blade roller 12 and feed roller 14 may operate to grip, feed, and cut the wire 34 as the wire 34 moves through the wire stripper 10. Referring to FIG. 3, a first pair 80 of rollers 50 may be aligned to feed wire 34 into a second pair 82 of rollers 50. First pair 80, which may include a top blade roller 12′ and a bottom feed roller 14′, may be aligned to feed wire 34 to second pair 82, which may include a top feed roller 14″ and a bottom blade roller 12″. During insertion of the wire 34 in the example shown, the wire 34 may be first contacted by the first pair 80 of parallel rollers 50 and may be passed on to the second pair 82 of parallel rollers 50, until the wire 34 exits the wire stripper 10. Each pair of parallel rollers 50 may have define a respective wire cutting zone 32, for example zones 32′ and 32″. The one or more pairs of parallel rollers 50 may each cut and pass the inserted wire 34 through the wire stripper 10. The pairs of rollers 50 may each form a respective longitudinal cut 34D on the wire 34, or may be aligned to cut in the same plane to cooperate together to form the same longitudinal cut 34D as shown.

Referring to FIGS. 1 and 2, the structural frame 52 of the wire stripper 10 may serve to mount the rollers 50 to permit the rollers 50 to be adjusted relative to one another during operation. For example, the rollers 50 or one or more of roller 12 and 14 may be mounted to frame 52 to permit adjustment of one or more of separation between the rollers 12 and 14, and the magnitude of converging bias force between the rollers 12 and 14. In the example shown in FIG. 2, each pair 80, 82 or one of them, may be mounted to adjust the converging force between the rollers 50. A converging force refers to a biasing force acting to push the rollers 12 and 14 together, and the increasing or decreasing of that force provides more or less grip, respectively, on the wire 34, as well as deeper or shallower, respectively, cutting of the sheath 34A. In the example shown, the top rollers 12 and 14 are mounted on a movable bracket 56, which is mounted to slide along axes 90, which may be parallel as shown. The bracket 56 may have column receivers 24 that are mounted to slide on columns 22 of the frame 52. The columns 22 may be mounted on a base 51, which mounts the bottom rollers 12 and 14 as shown. The columns 22 may support a cross member 20 with one or more biasing mechanisms 16 to increase or decrease the biasing force of each top roller toward the respective bottom roller. In the example shown each biasing mechanism 16 mounts a spring 17 that is compressed under normal operation between a stop 16D and movable bracket 56. The compression force on the spring 17 may be adjusted by rotating a shaft, such as a bolt shaft 16B, which may be coaxial with and support the spring 17. The shaft 16B may be rotated by relative rotation of a handle 16A and a nut such as wingnut 16C. The frame 52 may in some cases permit adjustment of a separation distance 86 between the rollers 12 and 14. In the example shown, in a neutral, unloaded position (where no wire 34 is inserted into the stripper 10), the adjustment of the spring 17 force indirectly adjusts the separation distance 86. Other mechanisms for adjusting separation and/or compressive force may be used.

Referring to FIG. 1, the parallel rollers 50 may be mounted to be rotated in use by a manual or automatic drive system. The wire stripper 10 shown in FIG. 1 may be driven by a roller drive 96, such as an electrical or other type of motor mounted to the frame 52. In other cases, the stripper 10 may be connected to receive power from an external motor, such as via a power drill torque transfer connection. A transmission may be provided to transfer rotational energy to the rollers 12 and 14 to permit adjustment of rotational speed. One or more controls may be provided to adjust speed. For example, each spindle may mount a gear or sprocket to receive rotational energy from the motor.

In some cases, in a method of use the stripper 10 or user may separate the insulative sheath 34A of the wire 34 from the wire core 34B, for example after or during the removal of the wire 34 from the wire-cutting zone 32. The stripper 10 may automatically assist in or carry out the separation stage for example using fingers, guides, wedges, or other suitable parts.

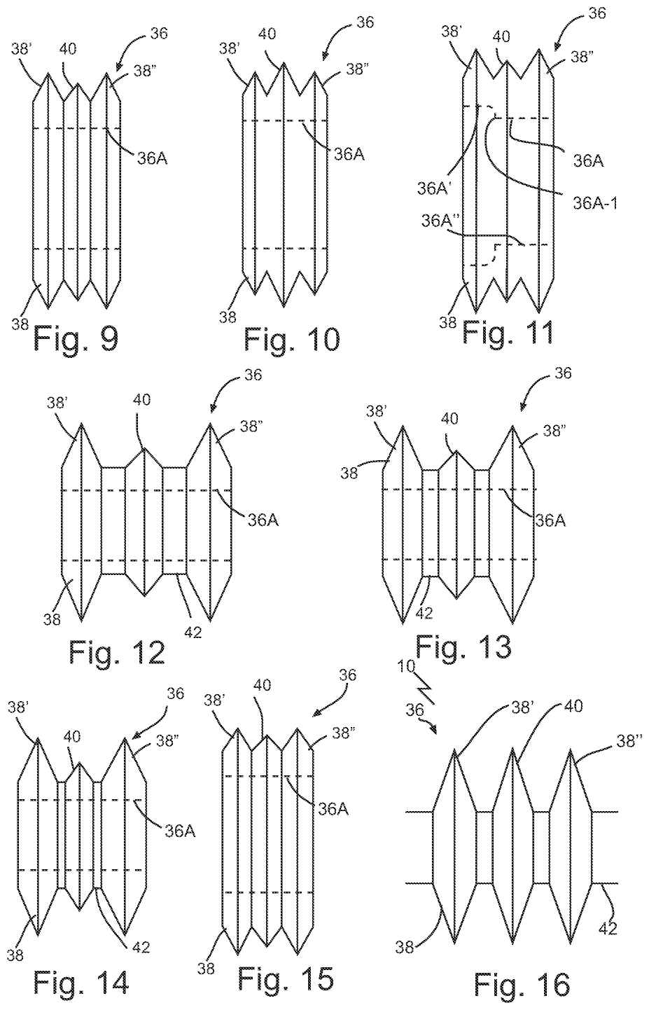

Referring to FIGS. 7-16, the wire cutter 36 may have a variety of different suitable shapes and structures. Referring to FIGS. 7-8, two or more cutting blades 40 may be used, for example with circumferential guide shoulders 38 (FIG. 7) or without shoulders 38 (FIG. 8). Referring to FIGS. 9-10 and 15, the relative sizing between the cutting blade 40 and guide shoulders 38 may vary, for example, the cutting blade 40 may be larger (greater diameter) than the guide shoulders 38 (FIG. 10), or the blade 40 may be smaller than the guide shoulders 38 (FIGS. 9 and 15). Referring to FIG. 11, the bore 36A may be structured with one or more tapered or axial shoulders 36A-1, for example defining portions 36A′ and 36A″ of the bore 36A having different inner diameters. The wire cutter example in FIG. 11 may be structured to fit on a correspondingly shaped blade roller, such as a blade roller with an axial shoulder. Referring to FIGS. 9-15, the cutting and guide blades may be arranged relative to one another in a suitable fashion, for example directly adjacent one another (FIGS. 9-11 and 15), or spaced various non-zero distances from one another (FIGS. 12-14). Referring to FIG. 16, the wire cutting blade 40 and one or more circumferential guide shoulders 38 may each be defined by independent rings, which may be independently mounted on the guide spindle 42. In the example of FIG. 16, the user may choose a suitable distance to space the blade 40 and shoulder(s) 38 as desired, for example based on the type, size and amount of wire the user is cutting, or the size of the corresponding wire receiving channel 46. There may be any suitable number of blades 40 and/or shoulders 38 attached to the blade spindle 42, for example, the user may choose the number of blades 40 to attach to the blade spindle 42 based on the type, size and amount of wire the user is cutting, or the size of the corresponding wire receiving channel 46.

In some cases, various of the embodiments may achieve one or more of the following benefits. The wire cutter 36 may avoid or minimize the effect or risk of knife walk, which is the lateral movement of the central blade 40 relative to the respective wire gripping portion 44 and/or wire zone wire insertion axis 32A, and/or relative to the blade spindle 42. The use of one or more guide shoulders 38 directs the wire 34 to align with the cutting blade 40 to achieve such effect. The wire cutter 36 may avoid or minimize the effect of wire walk, which is the lateral movement of the wire 34 relative to the wire zone wire insertion axis 32A (which is defined by the wire zone 32 in use) and that otherwise acts to move the wire 34 off center. The one or more guide shoulders 38 may contact the wire 34 in use to centralize or otherwise direct the wire 34 into an optimal cutting position relative to the cutting blade 40. The wire cutter 36 may improve the precision of the cutting action, resulting in less waste of precious core 34B material. In a conventional wire stripper, it is common for knife walk, blade walk, or improper roller to roller adjustments to cause nicking or cutting of core 34B, potentially severing braided portions of the core or damaging the core, leading to messy output from the stripper and/or less core material ultimately separated from the sheath. Core penetration is also helpful to avoid as it is known to dull the cutting blade. Copper wire cores 34B are particularly valuable, and even a 7-12% waste or downgrading of outputted copper material may significantly reduce the value of the outputted, separated core. In some cases, the use of a wire cutter 36 may reduce the precision required to operate the wire stripper 10, and may reduce the number of runs of a wire 34 through the stripper 10 required to adequately strip the wire 34. The use of guide shoulders 38 may reduce the demands on prior strippers 10 to perfectly align the wire cutter with the corresponding respective feed channel.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A wire stripper comprising:
a structural frame;
parallel rollers mounted on the structural frame to rotate relative to one another, one of the parallel rollers being a feed roller and the other being a blade roller; and
in which the blade roller has a wire cutter comprising a cutting blade and one or more circumferential guide shoulders, with the wire cutter aligned with a wire-gripping portion of the feed roller to define a wire-cutting zone.

2. The wire stripper of claim 1 in which the parallel rollers are structured to, in use, receive a wire that is inserted into the wire-cutting zone in a longitudinal direction between the parallel rollers, such that the wire contacts the feed roller, the cutting blade, and the one or more circumferential guide shoulders to direct the wire between the parallel rollers while the cutting blade longitudinally cuts the insulative sheath of the wire.

3. The wire stripper of claim 1 in which the feed roller has circumferential shoulders that are spaced between axial ends of the feed roller to define a circumferential wire-receiving channel that defines the wire-gripping portion and at least partially defines the wire-cutting zone.

4. The wire stripper of claim 3 in which the feed roller and the blade roller mesh together with the wire cutter fitting at least partially within the circumferential wire-receiving channel.

5. The wire stripper of claim 3 in which:
the cutting blade and a center axis of the circumferential wire-receiving channel are parallel and defined in the same plane; and
the one or more circumferential guide shoulders are aligned with one or more of opposed side walls of the circumferential wire-receiving channel.

6. The wire stripper of claim 5 in which the opposed side walls of the circumferential wire-receiving channel are tapered, and the one or more circumferential guide shoulders are V-shaped in cross-section with outer faces following the taper of the opposed side walls.

7. The wire stripper of claim 1 in which:
the feed roller defines a series of wire-gripping portions spaced between the axial ends of the feed roller;
the blade roller defines a series of wire cutters spaced between the axial ends of the blade roller; and
the series of wire-gripping portions and the series of wire cutters cooperate to define a series of wire-cutting zones, with each wire-cutting zone being defined by a respective wire cutter and a respective wire gripping portion.

8. The wire stripper of claim 7 in which each wire-cutting zone has a respective axial width corresponding to a maximum feed wire diameter, with the respective axial widths of each wire-cutting zone being different from one another.

9. The wire stripper of claim 1 in which:
the feed roller comprises a feed spindle that defines the wire-gripping portion; and
the blade roller comprises a blade spindle mounting the wire cutter as at least one ring that defines the cutting blade and one or more circumferential guide shoulders.

10. The wire stripper of claim 9 in which the ring is reversibly mounted on the blade spindle.

11. The wire stripper of claim 9 in which each of the cutting blade and one or more circumferential guide shoulders are defined by independent rings.

12. The wire stripper of claim 1 in which the one or more circumferential guide shoulders comprise left and right circumferential guide shoulders aligned on either side of the cutting blade.

13. The wire stripper of claim 1 in which the one or more circumferential guide shoulders comprise one or more guide blades.

14. The wire stripper of claim 1 in which the cutting blade comprises two or more cutting blades.

15. The wire stripper of claim 1 further comprising a roller drive connected to rotate one or both of the feed roller and blade roller.

16. The wire stripper of claim 1:
in which the parallel rollers comprise a first pair of parallel rollers;
the wire stripper comprises a second pair of parallel rollers; and
in which the first pair aligns with the second pair to define a wire receiving path.

17. The wire stripper of claim 1 further comprising a wire feed guide conduit structured to receive and permit passage, in use, of the wire into the wire-cutting zone between the parallel rollers.

18. A kit comprising the feed roller and blade roller of claim 1.

19. A method comprising rotating one or both of the feed roller and the blade roller of the wire stripper of claim 1 to cut an insulative sheath from a wire that is inserted within the wire-cutting zone.

20. A method comprising inserting a wire, which has a wire core and a insulative sheath, along an axis of the wire, through a wire-cutting zone, which is defined by a) a wire-gripping portion of a feed roller, and b) a wire cutter of a blade roller, the wire cutter comprising a cutting blade and one or more circumferential guide shoulders, the feed roller and the blade roller forming parallel rollers, in which during insertion of the wire, the blade roller and the feed roller are rotated relative to one another to grip the wire and to permit the cutting blade to form a longitudinal cut along the insulative sheath.

21. The method of claim 20 further comprising separating the insulative sheath from the wire after or during removal of the wire from the wire-cutting zone.

22. The method of claim 20 in which:
the one or more circumferential guide shoulders comprise left and right circumferential guide shoulders on either side of the cutting blade; and
during insertion of the insulated wire, the left and right circumferential guide shoulders guide the wire into contact with the cutting blade.
